(19) United States
(12) Patent Application Publication
(10) Pub. No.: US 2026/0017675 A1
(43) Pub. Date: Jan. 15, 2026

(54) INFORMATION MANAGEMENT SYSTEM AND METHOD

(71) Applicant: DealerCloud, LLC, San Jose, CA (US)

(72) Inventors: Nathan Ross Hollenbeck, San Jose, CA (US); Nicholas R. George, Gilroy, CA (US); Taylor A. Feezor, San Jose, CA (US); Jeremy T. Beaver, San Jose, CA (US); Jagdish Rajan, Brisbane, CA (US); Nicole Lerner, Martinez, CA (US); Scott Richard Pettitt, Morgan Hill, CA (US); Elwira M. Wilczynska, San Jose, CA (US)

(21) Appl. No.: 19/262,563

(22) Filed: Jul. 8, 2025

Related U.S. Application Data
(60) Provisional application No. 63/670,637, filed on Jul. 12, 2024.

(51) Int. Cl. G06Q 30/0201

(52) U.S. Cl. CPC G06Q 30/020121

(57) ABSTRACT

Concept 2:

A computer-implemented method, computer program product and computing system for: receiving a new sales lead from a potential customer for a dealership entity; processing the new sales lead from the potential customer for the dealership entity to determine if the potential customer has an existing relationship with a specific salesperson of the dealership entity; if the potential customer has an existing relationship with a specific salesperson of the dealership entity, routing the new sales lead to the specific salesperson of the dealership entity; and if the potential customer does not have an existing relationship with a specific salesperson of the dealership entity, distributing the new sales lead to a member of a pool of available salespeople of the dealership entity.

### RELATED APPLICATION(S)

This application claims the benefit of U.S. Provisional Application No. 63/670,637, filed on 12 Jul. 2024, the entire contents of which are incorporated herein by reference.

### TECHNICAL FIELD

This disclosure relates to information management systems and methods and, more particularly, to information management systems and methods utilized within dealership networks.

### BACKGROUND

Customer Relationship Management (CRM) programs have become essential tools in automotive dealerships, evolving from basic contact management systems in the 1990s to comprehensive platforms that support the entire customer lifecycle. Initially, dealerships used simple databases to store contact and service information, but as customer expectations grew and competition intensified, more advanced systems were developed to manage leads, sales, and service interactions. Modern automotive CRMs help dealerships capture leads from multiple sources, track sales opportunities through various pipeline stages, and maintain detailed customer profiles, including vehicle purchase history, financing details, and service records. These systems also support targeted marketing efforts through automated campaigns, service reminders, and promotional messaging, all aimed at enhancing customer engagement and retention.

In addition to managing sales and marketing, CRM programs are often integrated with other dealership systems, such as Dealer Management Systems (DMS), finance and insurance software, and OEM portals, allowing for seamless data flow across departments. This integration enables a more unified and personalized customer experience, both online and in-store. CRMs are also used by service departments to schedule appointments, send maintenance reminders, and follow up with customers after service visits. As the automotive industry shifts toward digital-first, omnichannel customer engagement, CRM programs play a strategic role in helping dealerships personalize communication, improve customer satisfaction, and drive long-term loyalty. Popular CRM platforms used in the automotive industry today include VinSolutions, DealerSocket, Elead CRM, and AutoRaptor. These systems have become indispensable in supporting operational efficiency and sustaining competitiveness in the modern dealership environment.

### SUMMARY OF DISCLOSURE

### Concept 2:

In one implementation, a computer-implemented method is executed on a computing device and includes: receiving a new sales lead from a potential customer for a dealership entity; processing the new sales lead from the potential customer for the dealership entity to determine if the potential customer has an existing relationship with a specific salesperson of the dealership entity; if the potential customer has an existing relationship with a specific salesperson of the dealership entity, routing the new sales lead to the specific salesperson of the dealership entity; and if the potential customer does not have an existing relationship with a specific salesperson of the dealership entity, distributing the new sales lead to a member of a pool of available salespeople of the dealership entity.

One or more of the following feathers may be included. A lead pipeline may be established between an online automotive marketplace and the dealership entity. Receiving a new sales lead from a potential customer for a dealership entity may include: receiving the new sales lead from the potential customer for the dealership entity via the lead pipeline between the online automotive marketplace and the dealership entity. The dealership entity may be one of a plurality of dealership entities associated with a dealership group. The dealership entity may be a vehicle dealership entity. Processing the new sales lead from the potential customer for the dealership entity to determine if the potential customer has an existing relationship with a specific salesperson of the dealership entity may include: determining if the new sales lead from the potential customer for the dealership entity is associated with an existing open opportunity. Processing the new sales lead from the potential customer for the dealership entity to determine if the potential customer has an existing relationship with a specific salesperson of the dealership entity may include: determining if the new sales lead from the potential customer for the dealership entity is associated with an existing non-disqualified lead. Processing the new sales lead from the potential customer for the dealership entity to determine if the potential customer has an existing relationship with a specific salesperson of the dealership entity may include: determining if the new sales lead from the potential customer for the dealership entity is a non-internet lead. Processing the new sales lead from the potential customer for the dealership entity to determine if the potential customer has an existing relationship with a specific salesperson of the dealership entity may include: identifying one or more loyalty aspects of the potential customer. Distributing the new sales lead to a member of a pool of available salespeople of the dealership entity may include one or more of: applying one or more queue overrides to the pool of available salespeople of the dealership entity; applying the most specific queue override if multiple queue overrides are applicable; and assigning the new sales lead to the coldest member of the pool of available salespeople.

In another implementation, a computer program product resides on a computer readable medium and has a plurality of instructions stored on it. When executed by a processor, the instructions cause the processor to perform operations including: receiving a new sales lead from a potential customer for a dealership entity; processing the new sales lead from the potential customer for the dealership entity to determine if the potential customer has an existing relationship with a specific salesperson of the dealership entity; if the potential customer has an existing relationship with a specific salesperson of the dealership entity, routing the new sales lead to the specific salesperson of the dealership entity; and if the potential customer does not have an existing relationship with a specific salesperson of the dealership entity, distributing the new sales lead to a member of a pool of available salespeople of the dealership entity.

One or more of the following feathers may be included. A lead pipeline may be established between an online automotive marketplace and the dealership entity. Receiving a new sales lead from a potential customer for a dealership entity may include: receiving the new sales lead from the potential customer for the dealership entity via the lead pipeline between the online automotive marketplace and the dealership entity. The dealership entity may be one of a plurality of dealership entities associated with a dealership group. The dealership entity may be a vehicle dealership entity. Processing the new sales lead from the potential customer for the dealership entity to determine if the potential customer has an existing relationship with a specific salesperson of the dealership entity may include: determining if the new sales lead from the potential customer for the dealership entity is associated with an existing open opportunity. Processing the new sales lead from the potential customer for the dealership entity to determine if the potential customer has an existing relationship with a specific salesperson of the dealership entity may include: determining if the new sales lead from the potential customer for the dealership entity is associated with an existing non-disqualified lead. Processing the new sales lead from the potential customer for the dealership entity to determine if the potential customer has an existing relationship with a specific salesperson of the dealership entity may include: determining if the new sales lead from the potential customer for the dealership entity is a non-internet lead. Processing the new sales lead from the potential customer for the dealership entity to determine if the potential customer has an existing relationship with a specific salesperson of the dealership entity may include: identifying one or more loyalty aspects of the potential customer. Distributing the new sales lead to a member of a pool of available salespeople of the dealership entity may include one or more of: applying one or more queue overrides to the pool of available salespeople of the dealership entity; applying the most specific queue override if multiple queue overrides are applicable; and assigning the new sales lead to the coldest member of the pool of available salespeople.

In another implementation, a computing system includes a processor and a memory system configured to perform operations including: receiving a new sales lead from a potential customer for a dealership entity; processing the new sales lead from the potential customer for the dealership entity to determine if the potential customer has an existing relationship with a specific salesperson of the dealership entity; if the potential customer has an existing relationship with a specific salesperson of the dealership entity, routing the new sales lead to the specific salesperson of the dealership entity; and if the potential customer does not have an existing relationship with a specific salesperson of the dealership entity, distributing the new sales lead to a member of a pool of available salespeople of the dealership entity.

One or more of the following feathers may be included. A lead pipeline may be established between an online automotive marketplace and the dealership entity. Receiving a new sales lead from a potential customer for a dealership entity may include: receiving the new sales lead from the potential customer for the dealership entity via the lead pipeline between the online automotive marketplace and the dealership entity. The dealership entity may be one of a plurality of dealership entities associated with a dealership group. The dealership entity may be a vehicle dealership entity. Processing the new sales lead from the potential customer for the dealership entity to determine if the potential customer has an existing relationship with a specific salesperson of the dealership entity may include: determining if the new sales lead from the potential customer for the dealership entity is associated with an existing open opportunity. Processing the new sales lead from the potential customer for the dealership entity to determine if the potential customer has an existing relationship with a specific salesperson of the dealership entity may include: determining if the new sales lead from the potential customer for the dealership entity is associated with an existing non-disqualified lead. Processing the new sales lead from the potential customer for the dealership entity to determine if the potential customer has an existing relationship with a specific salesperson of the dealership entity may include: determining if the new sales lead from the potential customer for the dealership entity is a non-internet lead. Processing the new sales lead from the potential customer for the dealership entity to determine if the potential customer has an existing relationship with a specific salesperson of the dealership entity may include: identifying one or more loyalty aspects of the potential customer. Distributing the new sales lead to a member of a pool of available salespeople of the dealership entity may include one or more of: applying one or more queue overrides to the pool of available salespeople of the dealership entity; applying the most specific queue override if multiple queue overrides are applicable; and assigning the new sales lead to the coldest member of the pool of available salespeople.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an information management process according to an embodiment of the present disclosure;

FIG. 2 is a diagrammatic view of a communication instance monitored by the information management process of FIG. 1 according to an embodiment of the present disclosure;

FIG. 3 is a flowchart of the information management process of FIG. 1 according to an embodiment of the present disclosure;

FIG. 4 is another flowchart of the information management process of FIG. 1 according to an embodiment of the present disclosure; and

FIG. 5 is another flowchart of the information management process of FIG. 1 according to an embodiment of the present disclosure.

Like reference symbols in the various drawings indicate like elements.

### DETAILED DESCRIPTION OF THE PREFERRED EMBODIMENTS

### System Overview

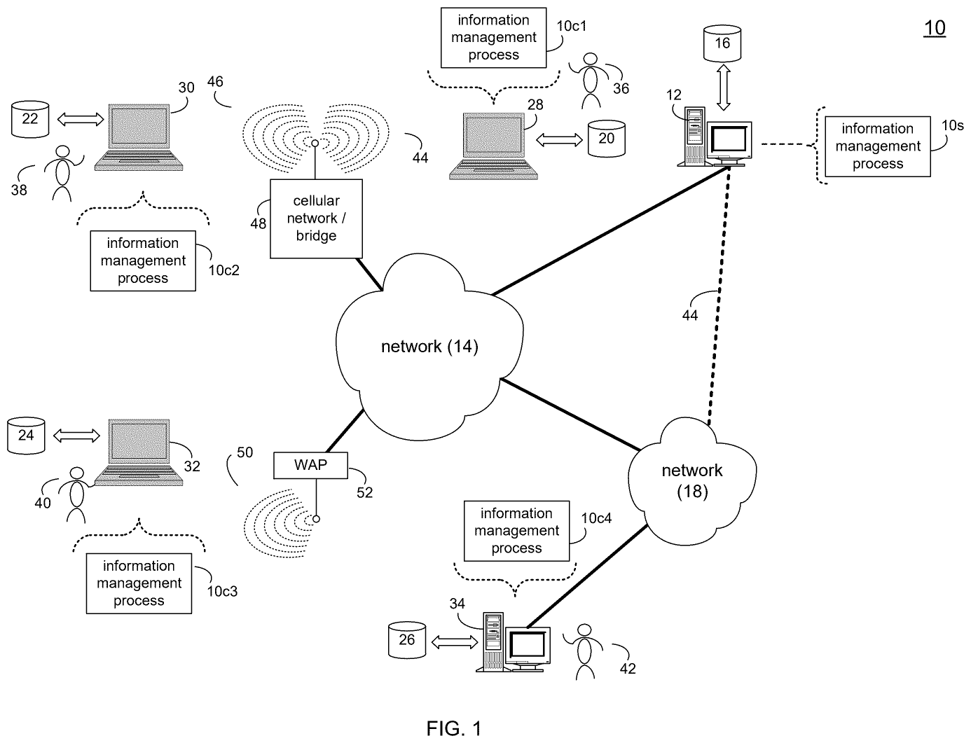

Referring to FIG. 1, there is shown information management process 10. Information management process 10 may be implemented as a server-side process, a client-side process, or a hybrid server-side/client-side process. For example, information management process 10 may be implemented as a purely server-side process via information management process 10s. Alternatively, information management process 10 may be implemented as a purely client-side process via one or more of information management process 10c1, information management process 10c2, information management process 10c3, and information management process 10c4. Alternatively still, information management process 10 may be implemented as a hybrid server-side/client-side process via information management process 10s in combination with one or more of information management process 10c1, information management process 10c2, information management process 10c3, and information management process 10c4. Accordingly, information management process 10 as used in this disclosure may include any combination of information management process 10s, information management process 10c1, information management process 10c2, information management process 10c3, and information management process 10c4.

Information management process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing platform.

The instruction sets and subroutines of information management process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random-access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of information processes 10c1, 10c2, 10c3, 10c4 may include but are not limited to a web browser, a game console user interface, a mobile device user interface, or a specialized application (e.g., an application running on e.g., the Android tm platform, the iOS tm platform, the Windows tm platform, the Linux tm platform or the UNIX tm platform). The instruction sets and subroutines of information processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a tablet computer (not shown), laptop computers 28, 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows tm, Android tm, iOS tm, Linux tm, or a custom operating system.

Users 36, 38, 40, 42 may access information management process 10 directly through network 14 or through secondary network 18. Further, information management process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and laptop computer 30 are shown wirelessly coupled to network 14 via wireless communication channels 44, 46 (respectively) established between laptop computers 28, 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11 g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

### Information Management Process Overview

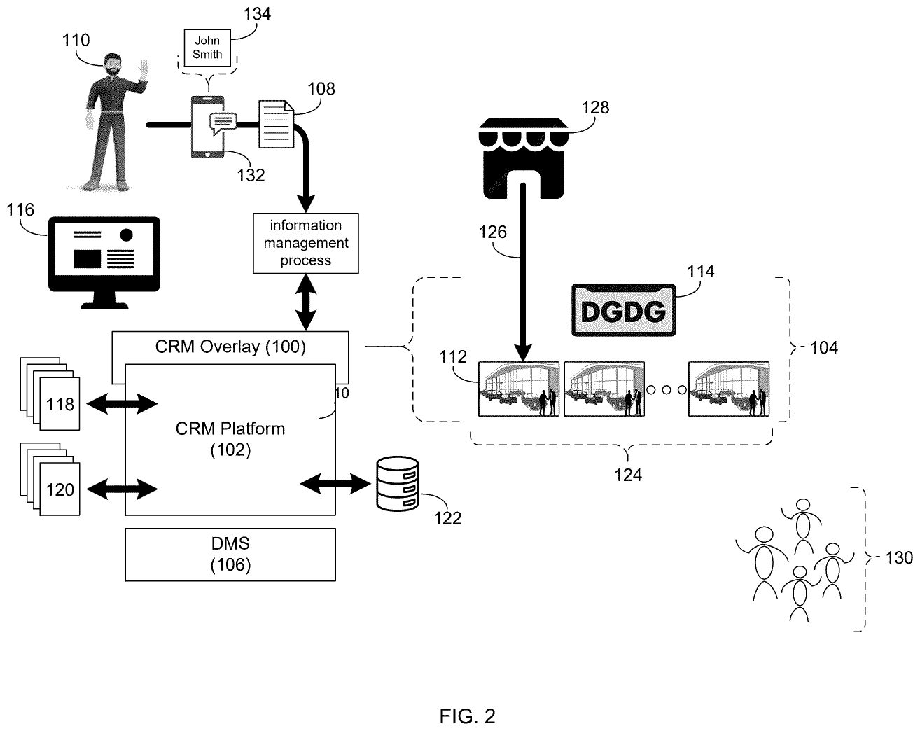

Referring also to FIG. 2 and as will be discussed below in greater detail, information management process 10 may be configured to function as a customer relationship management platform (CRM) overlay (e.g., CRM overlay 100) that will interact with a generic customer relationship management platform (e.g., generic CRM platform 102). Such a generic customer relationship management platform (e.g., generic CRM platform 102) may be an existing CRM platform that is currently being utilized within a dealership group. Accordingly, being information management process 10 may function as a CRM overlay (e.g., CRM overlay 100), information management process 10 may provide enhanced functionality and capabilities to the existing CRM platform (e.g., generic CRM platform 102) of the dealer group without requiring the financial and technical investment required to upgrade to a new CRM platform.

### Concept 1:

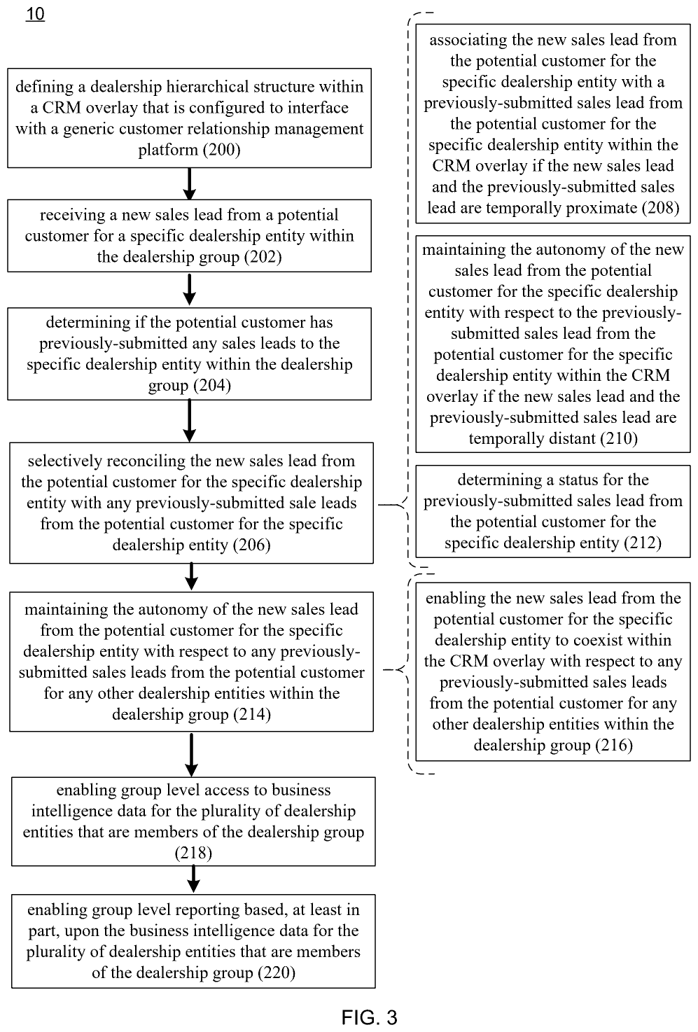

Referring also to FIG. 3, information management process 10 may define 200 a dealership hierarchical structure (e.g., dealership hierarchical structure 104) within a CRM overlay (e.g., CRM overlay 100) that is configured to interface with a generic customer relationship management platform (e.g., generic CRM platform 102). The generic customer relationship management platform (e.g., generic CRM platform 102) may be a configurable and programmable customer relationship management platform.

### The CRM Platform:

A CRM platform (e.g., generic CRM platform 102), or Customer Relationship Management platform, is a software system designed to help businesses manage their interactions with current and potential customers. It serves as a centralized hub for collecting, organizing, and analyzing customer information, including contact details, communication history, sales activity, support requests, and marketing interactions. By consolidating this information into one platform, a CRM (e.g., generic CRM platform 102) may enable companies to improve customer service, streamline processes, track leads and sales, and build stronger, more personalized relationships with their customers.

At its core, a CRM platform (e.g., generic CRM platform 102) typically includes tools for contact management, sales tracking, marketing automation, and customer support. More advanced platforms may also offer features like workflow automation, analytics and reporting, mobile access, integration with other business systems (e.g., email, accounting, or e-commerce platforms), and AI-powered insights to help users prioritize tasks or predict customer behavior. Popular CRM platforms include Salesforce, HubSpot, Microsoft Dynamics 365, Zoho CRM, and Pipedrive, among others.

In practical terms, a CRM platform (e.g., generic CRM platform 102) helps different departments (e.g., sales, marketing, and customer service) stay aligned by giving them access to the same up-to-date customer data. For example, a sales team can track a lead's journey from the first contact to a closed deal, while a customer support team can view previous interactions to provide faster, more informed assistance. Ultimately, a CRM platform (e.g., generic CRM platform 102) helps businesses boost customer satisfaction, increase efficiency, and drive revenue growth by making customer data actionable and accessible across the organization.

The CRM Platform within a Vehicle Dealership:

A CRM platform (e.g., generic CRM platform 102) may play an important role in the operations of a vehicle dealership by helping manage customer interactions across the entire sales and service lifecycle. In a dealership environment, a CRM platform (e.g., generic CRM platform 102) may serve as a digital backbone for tracking leads, organizing customer data, automating communication, and improving customer retention; ultimately supporting both the sales and service departments in delivering a more efficient and personalized experience.

When a potential customer first interacts with the dealership (e.g., by walking in, filling out an online form, or calling about a vehicle), the CRM platform (e.g., generic CRM platform 102) may capture their contact details and logs the nature of their inquiry. Sales staff may then use the system to track follow-ups, schedule test drives, record preferences (e.g., desired vehicle models, features, and budget), and set reminders for future communication. The CRM platform may also log all touchpoints, so if a customer returns weeks or months later, staff have a complete history of past interactions at their fingertips, enabling a seamless continuation of the sales process.

In addition to sales management, a CRM platform (e.g., generic CRM platform 102) may integrate with marketing tools to send targeted emails, promotional offers, or service reminders based on customer profiles and behaviors. For example, a CRM platform (e.g., generic CRM platform 102) may automatically notify a customer when their lease is nearing its end or send a coupon for their next oil change. On the service side, the CRM platform (e.g., generic CRM platform 102) may track vehicle service histories, schedule maintenance appointments, and flag warranty or recall issues, helping build trust and long-term customer relationships.

Moreover, dealership CRM platforms may integrate with inventory systems, finance and insurance platforms, and digital retailing tools, thus allowing for real-time updates on vehicle availability, financing options, and trade-in values; all of which can be communicated effectively to customers during their decision-making process. Management may also use CRM-generated analytics and dashboards to monitor team performance, conversion rates, and customer satisfaction metrics.

In summary, a CRM platform (e.g., generic CRM platform 102) in a vehicle dealership helps coordinate sales, service, and marketing efforts by organizing customer data, automating routine tasks, and enabling staff to deliver timely, relevant, and personalized service, which may lead to increased sales efficiency, stronger customer relationships, and improved retention over the long term.

### The CRM Overlay:

The CRM overlay (e.g., CRM overlay 100) may include a dealer CRM solution that runs on top of and/or interfaces with the generic customer relationship management platform (e.g., generic CRM platform 102).

A CRM overlay (e.g., CRM overlay 100) in the context of a vehicle dealership refers to an add-on interface, toolset, or layer of functionality that integrates with the dealership's existing CRM platform (e.g., generic CRM platform 102) to enhance or customize its capabilities. Rather than replacing the core CRM platform (e.g., generic CRM platform 102), a CRM overlay (e.g., CRM overlay 100) works on top of it, adding features such as automation, lead scoring, workflow enhancements, data enrichment, or improved user interfaces tailored specifically to dealership needs.

In a vehicle dealership, a CRM overlay (e.g., CRM overlay 100) may serve several important purposes. For example, it can streamline sales processes by providing real-time inventory visibility, pricing tools, or integrated digital retailing features, allowing salespeople to quickly generate quotes or offers within the CRM platform (e.g., generic CRM platform 102). It might also include customer engagement enhancements like automated follow-up schedules, texting or chat functionality, and dynamic email templates personalized for different stages of the customer journey. Some overlays also add analytics dashboards that track performance metrics such as lead response time, appointment show rates, or service-to-sales conversions, offering better visibility and accountability for managers.

CRM overlays (e.g., CRM overlay 100) may be especially valuable when the base CRM platform (e.g., generic CRM platform 102) lacks modern features or dealership-specific workflows. Instead of switching to a new CRM platform entirely, a dealership can implement an overlay (e.g., CRM overlay 100) to modernize the user experience, introduce AI-driven lead prioritization, or ensure better integration with tools like dealership management systems (DMS), inventory feeds, or finance and insurance platforms.

In summary, a CRM overlay (e.g., CRM overlay 100) may enhance the functionality of an existing CRM platform (e.g., generic CRM platform 102) in a dealership by providing additional tools, automation, integrations, or interfaces designed specifically for the automotive retail environment, while allowing dealerships to get more value out of their existing CRM platform (e.g., generic CRM platform 102) without undergoing a full system replacement.

### The Dealership Hierarchical Structure:

A dealership hierarchical structure (e.g., dealership hierarchical structure 104) may identify a plurality of dealership entities (e.g., a plurality of vehicle dealership entities) associated with a dealership group (e.g., a vehicle dealership group), which represents an organized, multi-level arrangement in which multiple independently operating dealerships are managed under a central, parent organization. This structure is common in the automotive retail industry, where large dealership groups own and oversee several dealership locations, each potentially representing different brands, geographic areas, or customer markets.

At the top of the hierarchy (e.g., dealership hierarchical structure 104) is the vehicle dealership group, which serves as the parent entity. This group may be a privately held company, a public corporation, or a regional auto group that owns and operates multiple dealership entities. The dealership group may be responsible for high-level management functions such as corporate governance, financial oversight, group-level marketing strategies, brand partnerships, technology infrastructure, and overall business development. It may also centralize support services such as human resources, legal, IT, compliance, and procurement to streamline operations across its dealership network.

Beneath the dealership group may be the plurality of individual vehicle dealership entities. Each dealership entity may operate as its own business unit, often with its own general manager, sales and service staff, and dedicated facilities. These dealerships may represent one or more automotive OEM (original equipment manufacturer) brands (e.g., Ford, Toyota, or BMW) and operate under different franchise agreements. While these entities may have day-to-day operational autonomy, they adhere to policies, systems, and performance standards set by the parent group. For example, they may all use the same CRM platform, DMS (dealer management system), advertising vendors, or customer satisfaction procedures.

The hierarchical relationship may allow for scalable management and standardized operations, while still enabling each dealership entity to address local market conditions, customer demographics, and regional sales opportunities. This structure (e.g., dealership hierarchical structure 104) may also facilitate data sharing, performance benchmarking, and resource allocation across the entire group. Additionally, group-level executives or directors may oversee clusters of dealerships (e.g., by region or brand) to provide strategic alignment and ensure consistent execution of company goals.

In summary, a vehicle dealership hierarchical structure (e.g., dealership hierarchical structure 104) with a plurality of dealership entities under a single group may allow for centralized leadership and operational efficiency, while still granting each dealership the flexibility to operate effectively in its local market, thus supporting growth, brand diversity, cost optimization, and the consistent delivery of customer service across a large dealership network.

### The Dealership Management Platform

A Dealer Management System (e.g., DMS 106) is a comprehensive software platform used by automotive dealerships to manage the core operational functions of the business, including inventory management, vehicle sales, service and repair operations, parts ordering, finance and accounting, and compliance tracking. The DMS (e.g., DMS 106) acts as the dealership's central business system, providing back-office functionality and handling day-to-day operations that keep the dealership running smoothly.

In a dealership network, the DMS (e.g., DMS 106) is typically deployed at each dealership entity level, though larger dealership groups may centralize certain DMS functions across multiple rooftops. The DMS (e.g., DMS 106) may track every vehicle from acquisition to sale, logs service history for every repair order, manages parts availability and pricing, processes transactions, and generates key financial reports. Leading DMS platforms in the industry include CDK Global, Reynolds & Reynolds, Dealertrack, and Tekion.

The CRM platform (e.g., generic CRM platform 102), on the other hand, is primarily focused on customer engagement and relationship management, handling lead tracking, sales communications, marketing campaigns, and customer follow-up. While the DMS (e.g., DMS 106) manages operational data, the CRM (e.g., generic CRM platform 102) manages interaction data. To work efficiently within a dealership or dealership group, the DMS and CRM platforms CRM (e.g., DMS 106 and generic CRM platform 102) must interact and exchange information, creating a seamless workflow between customer-facing and operational processes.

The interaction between a DMS (e.g., DMS 106) and a CRM platform (e.g., generic CRM platform 102), typically includes bidirectional data integration, allowing each system to stay updated with relevant data. For example, when a customer schedules a service appointment through the CRM (e.g., generic CRM platform 102), that appointment detail may be passed to the DMS (e.g., DMS 106) so the service department can prepare the work order, allocate technician time, and check parts availability. Conversely, once the service is completed in the DMS (e.g., DMS 106), the CRM (e.g., generic CRM platform 102) can be updated with the service outcome, triggering a thank-you message or follow-up survey. In the sales process, a lead entered into the CRM (e.g., generic CRM platform 102) may progress to a deal in the DMS (e.g., DMS 106), where it is tracked as part of the official transaction and vehicle delivery process. Updates such as vehicle availability, price changes, or inventory data in the DMS (e.g., DMS 106) can flow into the CRM (e.g., generic CRM platform 102), ensuring sales teams always have accurate and timely information when working with customers.

This integration is especially important in dealership groups with multiple stores, where a centralized CRM platform (e.g., generic CRM platform 102) may interface with multiple DMS instances to present a unified view of customer interactions across the network. Such synchronization ensures that customer records are consistent regardless of which location they visit, supporting both operational efficiency and a cohesive customer experience.

In summary, a DMS (e.g., DMS 106) is the operational backbone of a dealership, while the CRM (e.g., generic CRM platform 102) manages customer relationships and sales engagement. When integrated, these systems allow dealerships to coordinate customer-facing activities with operational processes, improving efficiency, accuracy, and the overall customer journey across the dealership network.

Information management process 10 may receive 202 a new sales lead (e.g., new sales lead 108) from a potential customer (e.g., potential customer 110) for a specific dealership entity (e.g., dealership entity 112) within the dealership group (e.g., dealership group 114).

Such a new sales lead (e.g., new sales lead 108) from a potential customer (e.g., potential customer 110) for a specific dealership entity (e.g., dealership entity 112) within the dealership group (e.g., dealership group 114) may be any type of sales lead, examples of which may include but are not limited to: an internet-based sales lead, a physical (e.g., walk-in) sales lead; and a telephone-based sales lead.

For example, such a new sales lead (e.g., new sales lead 108) from a potential customer (e.g., potential customer 110) may include but is not limited to a internet-based inquiry made by the potential customer (e.g., potential customer 110) via a website (e.g., website 116) for a specific dealership entity (e.g., dealership entity 112) within the dealership group (e.g., dealership group 114). Specifically, such a new sales lead 108) from the potential customer (e.g., potential customer 110) may request information concerning a specific vehicle (e.g., a Ford F-150 pickup truck) available via the specific dealership entity (e.g., dealership entity 112).

Upon receiving 202 such a new sales lead (e.g., new sales lead 108) from the potential customer (e.g., potential customer 110), information management process 10 may determine 204 if the potential customer (e.g., potential customer 110) has previously-submitted any sales leads to the specific dealership entity (e.g., dealership entity 112) within the dealership group (e.g., dealership group 114).

For example, assume that the new sales lead (e.g., new sales lead 108) identifies the potential customer (e.g., potential customer 110) as John Smith of 1 Main Street in San Jose, California, who has a mobile phone number of 123-456-7890. Further assume that the new sales lead (e.g., new sales lead 108) states that the potential customer (e.g., potential customer 110) is interested in a 2025 Ford F-150 pickup truck having an inventory number of A72156. Accordingly and when making such a determination 104, information management process 10 may search lead records (e.g., lead records 118) within CRM platform (e.g., generic CRM platform 102) and/or the DMS (e.g., DMS 106) to determine if a potential customer named John Smith of 1 Main Street in San Jose, California, who has a mobile phone number of 123-456-7890 has previously-submitted any sales leads to the specific dealership entity (e.g., dealership entity 112) within the dealership group (e.g., dealership group 114).

If the potential customer (e.g., potential customer 110) has previously-submitted any sales leads for the specific dealership entity (e.g., dealership entity 112) within the dealership group (e.g., dealership group 114), information management process 10 may selectively reconcile 206 the new sales lead (e.g., new sales lead 108) from the potential customer (e.g., potential customer 110) for the specific dealership entity (e.g., dealership entity 112) with any previously-submitted sales leads (e.g., previously-submitted sales lead 120) from the potential customer (e.g., potential customer 110) for the specific dealership entity (e.g., dealership entity 112).

The manner in which information management process 10 selectively reconciles 206 the new sales lead (e.g., new sales lead 108) with the previously-submitted sales leads (e.g., previously-submitted sales lead 120) may vary depending upon the relationship between the new and previously-submitted sales leads.

### Temporally Proximate Sales Leads:

For example and when selectively reconciling 206 the new sales lead (e.g., new sales lead 108) from the potential customer (e.g., potential customer 110) for the specific dealership entity (e.g., dealership entity 112) with any previously-submitted sales leads (e.g., previously-submitted sales lead 120) from the potential customer (e.g., potential customer 110) for the specific dealership entity (e.g., dealership entity 112), information management process 10 may associate 208 the new sales lead (e.g., new sales lead 108) from the potential customer (e.g., potential customer 110) for the specific dealership entity (e.g., dealership entity 112) with a previously-submitted sales leads (e.g., previously-submitted sales lead 120) from the potential customer (e.g., potential customer 110) for the specific dealership entity (e.g., dealership entity 112) within the CRM overlay (e.g., CRM overlay 100) if the new sales lead (e.g., new sales lead 108) and the previously-submitted sales leads (e.g., previously-submitted sales lead 120) are temporally proximate.

As discussed above, the potential customer (e.g., potential customer 110) is John Smith of 1 Main Street in San Jose, California, who has a mobile phone number of 123-456-7890, wherein the new sales lead (e.g., new sales lead 108) concerns a 2025 Ford F-150 pickup truck having an inventory number of A72156. Assume that the new sales lead (e.g., new sales lead 108) was initiated on 1 Jun. 2025. Further, assume that the potential customer (e.g., potential customer 110) has a previously-submitted sales lead (e.g., previously-submitted sales lead 120) for the specific dealership entity (e.g., dealership entity 112) within the dealership group (e.g., dealership group 114), wherein previously-submitted sales lead 120 concerned a different 2025 Ford F-150 pickup truck having an inventory number of A71463. Further assume for this example that previously-submitted sales lead 120 was submitted one month prior. Accordingly and being the new sales lead (e.g., new sales lead 108) and the previously-submitted sales lead (e.g., previously-submitted sales lead 120) are only one month apart, information management process 10 may deem the new sales lead (e.g., new sales lead 108) and the previously-submitted sales leads (e.g., previously-submitted sales lead 120) to be temporally proximate and may associate 208 these sales leads. Accordingly, if the previously-submitted sales lead (e.g., previously-submitted sales lead 120) was assigned to salesperson Dan Jones, information management process 10 may associate 208 this new sales lead (e.g., new sales lead 108) with the previously-submitted sales lead (e.g., previously-submitted sales lead 120) and, therefore, this new sales lead (e.g., new sales lead 108) may also be assigned to salesperson Dan Jones.

### Temporally Distant Sales Leads:

Further and when selectively reconciling 206 the new sales lead (e.g., new sales lead 108) from the potential customer (e.g., potential customer 110) for the specific dealership entity (e.g., dealership entity 112) with any previously-submitted sales leads (e.g., previously-submitted sales lead 120) from the potential customer (e.g., potential customer 110) for the specific dealership entity (e.g., dealership entity 112), information management process 10 may maintain 210 the autonomy of the new sales lead (e.g., new sales lead 108) from the potential customer (e.g., potential customer 110) for the specific dealership entity (e.g., dealership entity 112) with respect to the previously-submitted sales leads (e.g., previously-submitted sales lead 120) from the potential customer (e.g., potential customer 110) for the specific dealership entity (e.g., dealership entity 112) within the CRM overlay (e.g., CRM overlay 100) if the new sales lead (e.g., new sales lead 108) and the previously-submitted sales leads (e.g., previously-submitted sales lead 120) are temporally distant.

Continuing with the above-stated example, assume that the previously-submitted sales lead (e.g., previously-submitted sales lead 120) for the specific dealership entity (e.g., dealership entity 112) within the dealership group (e.g., dealership group 114) concerned a different 2025 Ford F-150 pickup truck having an inventory number of A71463, wherein this previously-submitted sales lead 120 was submitted nine months prior. Accordingly and being the new sales lead (e.g., new sales lead 108) and the previously-submitted sales lead (e.g., previously-submitted sales lead 120) are nine months apart, information management process 10 may deem the new sales lead (e.g., new sales lead 108) and the previously-submitted sales leads (e.g., previously-submitted sales lead 120) to be temporally distant and may maintain 210 the autonomy of the new sales lead (e.g., new sales lead 108) with respect to the previously-submitted sales lead (e.g., previously-submitted sales lead 120). Accordingly, if the previously-submitted sales lead (e.g., previously-submitted sales lead 120) was assigned to salesperson Dan Jones, information management process 10 may maintain 210 the autonomy of the new sales lead (e.g., new sales lead 108) with respect to the previously-submitted sales lead (e.g., previously-submitted sales lead 120) and, therefore, this new sales lead (e.g., new sales lead 108) may be assigned to a different salesperson (e.g., the next salesperson in the assignment queue).

### The Status of the Previously-Submitted Leads:

Additionally and when selectively reconciling 206 the new sales lead (e.g., new sales lead 108) from the potential customer (e.g., potential customer 110) for the specific dealership entity (e.g., dealership entity 112) with any previously-submitted sales leads (e.g., previously-submitted sales lead 120) from the potential customer (e.g., potential customer 110) for the specific dealership entity (e.g., dealership entity 112), information management process 10 may determine 212 a status for the previously-submitted sales leads (e.g., previously-submitted sales lead 120) from the potential customer (e.g., potential customer 110) for the specific dealership entity (e.g., dealership entity 112).

Continuing with the above-stated example, assume that the previously-submitted sales lead (e.g., previously-submitted sales lead 120) for the specific dealership entity (e.g., dealership entity 112) within the dealership group (e.g., dealership group 114) concerned a different 2022 Ford F-150 pickup truck having an inventory number of A64104, wherein this previously-submitted sales lead 120 was submitted 3½ years prior. Normally, being the new sales lead (e.g., new sales lead 108) and the previously-submitted sales lead (e.g., previously-submitted sales lead 120) are 3½ years apart, information management process 10 would typically deem the new sales lead (e.g., new sales lead 108) and the previously-submitted sales leads (e.g., previously-submitted sales lead 120) temporally distant and may maintain the autonomy of the new sales lead (e.g., new sales lead 108) with respect to the previously-submitted sales lead (e.g., previously-submitted sales lead 120). However, information management process 10 may determine 212 a status for the previously-submitted sales leads (e.g., previously-submitted sales lead 120) from the potential customer (e.g., potential customer 110) for the specific dealership entity (e.g., dealership entity 112). Assume that the previously-submitted sales lead (e.g., previously-submitted sales lead 120) from 3½ years ago resulted in a sale of the 2022 Ford F-150 pickup truck having an inventory number of A64104. Accordingly, if the previously-submitted sales lead (e.g., previously-submitted sales lead 120) was assigned to salesperson Dan Jones (who closed the sale of the 2022 Ford F-150 pickup truck), information management process 10 may assign this new sales lead (e.g., new sales lead 108) to the same salesperson (Dan Jones), as this is basically a returning customer of Dan Jones.

### Previous Sales Lead to Another Dealership:

If the potential customer (e.g., potential customer 110) has previously-submitted sales leads (e.g., previously-submitted sales lead 120) within the dealership group (e.g., dealership group 114), information management process 10 may maintain 214 the autonomy of the new sales lead (e.g., new sales lead 108) from the potential customer (e.g., potential customer 110) for the specific dealership entity (e.g., dealership entity 112) with respect to any previously-submitted sales leads (e.g., previously-submitted sales lead 120) from the potential customer (e.g., potential customer 110) for any other dealership entities within the dealership group (e.g., dealership group 114).

For example and when maintaining 214 the autonomy of the new sales lead (e.g., new sales lead 108) from the potential customer (e.g., potential customer 110) for the specific dealership entity (e.g., dealership entity 112) with respect to any previously-submitted sales leads (e.g., previously-submitted sales lead 120) from the potential customer (e.g., potential customer 110) for any other dealership entities within the dealership group (e.g., dealership group 114), information management process 10 may enable 216 the new sales lead (e.g., new sales lead 108) from the potential customer (e.g., potential customer 110) for the specific dealership entity (e.g., dealership entity 112) to coexist within the CRM overlay (e.g., CRM overlay 100) with respect to any previously-submitted sales leads (e.g., previously-submitted sales lead 120) from the potential customer (e.g., potential customer 110) for any other dealership entities within the dealership group (e.g., dealership group 114).

As discussed above, the potential customer (e.g., potential customer 110) is John Smith of 1 Main Street in San Jose, California, who has a mobile phone number of 123-456-7890, wherein the new sales lead (e.g., new sales lead 108) concerns a 2025 Ford F-150 pickup truck having an inventory number of A72156. Assume that the new sales lead (e.g., new sales lead 108) was initiated on 1 Jun. 2025. Further, assume that the potential customer (e.g., potential customer 110) has a previously-submitted sales lead (e.g., previously-submitted sales lead 120) for a different dealership (e.g., different dealership entity 112) within the dealership group (e.g., dealership group 114), wherein previously-submitted sales lead 120 was submitted to a Toyota dealership within dealership group 114 (as opposed to a Ford dealership within dealership group 114) and concerned a 2025 Toyota Tundra pickup truck having an inventory number of A71463.

Accordingly and being the new and previous sales leads concern two different dealerships (a Ford dealership versus a Toyota dealership) within the dealership group (e.g., dealership group 114), information management process 10 may enable 216 the new sales lead (e.g., new sales lead 108) from the potential customer (e.g., potential customer 110) for the specific dealership entity (e.g., dealership entity 112) to coexist within the CRM overlay (e.g., CRM overlay 100) with respect to the previously-submitted sales lead (e.g., previously-submitted sales lead 120) from the potential customer (e.g., potential customer 110) for the other dealership entity (e.g., the Toyota dealership) within the dealership group (e.g., dealership group 114).

Information management process 10 may enable 218 group level access to business intelligence data (e.g., business intelligence data 122) for the plurality of dealership entities that are members of the dealership group (e.g., dealership group 114).

Business intelligence data (e.g., business intelligence data 122) within a dealership group (e.g., dealership group 114) may refer to the collection, integration, analysis, and visualization of operational and customer data across multiple dealership entities to support strategic decision-making and performance optimization. In a dealership group, where multiple vehicle dealerships are owned or managed under a single parent organization, business intelligence data (e.g., business intelligence data 122) may enable leadership to monitor key performance indicators (KPIs), identify trends, compare performance across stores or brands, and make data-driven decisions to improve profitability, efficiency, and customer satisfaction.

This data (e.g., business intelligence data 122) is typically aggregated from a variety of sources, including the Dealer Management System (e.g., DMS 106), Customer Relationship Management platforms (e.g., generic CRM platform 102), financial systems, inventory tracking tools, service scheduling platforms, and digital marketing systems.

Examples of business intelligence data (e.g., business intelligence data 122) may include but are not limited to:
Sales metrics (e.g., units sold, gross profit per vehicle, close rates);
Inventory performance (e.g., days on lot, aging inventory, turn rates);
Service and fixed operations data (e.g., repair order counts, labor hours, parts revenue);
Customer engagement data (e.g., lead response times, appointment conversion rates, satisfaction scores);
Marketing effectiveness (e.g., campaign ROI, lead sources, digital ad performance); and
Financial indicators (e.g., revenue, expenses, profit margins, departmental performance).

In a dealership group, where complexity increases with size and scope, business intelligence data (e.g., business intelligence data 122) acts as a unifying layer that brings clarity to operations. Such data (e.g., business intelligence data 122) may help optimize inventory distribution, fine-tune pricing strategies, align staffing with demand, reduce inefficiencies, and enhance the overall customer experience. Ultimately, business intelligence data may provide dealership groups with the insight needed to make proactive, informed decisions that drive growth and competitiveness across all their stores.

Additionally, information management process 10 may enable 220 group level reporting based, at least in part, upon the business intelligence data (e.g., business intelligence data 122) for the plurality of dealership entities that are members of the dealership group (e.g., dealership group 114).

Dealer group—level reporting based on business intelligence data (e.g., business intelligence data 122) may include consolidated, comparative, and trend-driven insights that allow leadership at the group level to monitor and manage performance across a network of dealerships. This type of reporting goes beyond single-rooftop metrics by aggregating data from multiple dealership entities and presenting it in a way that supports enterprise-level visibility, decision-making, and strategic planning.

At the dealer group level, business intelligence reporting may include the following categories:
Sales Performance Reports: These reports include data on total vehicles sold (new and used), gross profit per unit (front-end and back-end), finance and insurance (F&I) penetration rates, closing ratios, lead-to-sale conversion rates, and comparisons across locations or brands. They help leadership identify high-performing stores, underperforming teams, and overall group sales trends.
Inventory Analytics: Group-level inventory reports show total stock levels, vehicle aging, turn rates, stocking mix, and transfer activity between stores. This allows for optimization of inventory allocation, reduction of holding costs, and identification of overstock or slow-moving vehicles across the network.
Service and Fixed Operations Reporting: BI reports from the service department include repair order volume, average revenue per RO, labor hours sold, parts-to-labor ratios, technician efficiency, service retention rates, and customer satisfaction scores. These reports help monitor shop productivity, customer loyalty, and profitability across stores.
Financial and Profitability Reporting: These reports consolidate revenue, expenses, gross margin, net profit, and departmental contribution by location. They provide dealership groups with a clear view of financial health at both macro and micro levels, supporting budgeting, forecasting, and performance benchmarking.
Customer Engagement and CRM Metrics: Dealer group-level CRM reports track lead volumes, response times, communication effectiveness (calls, emails, texts), appointment show rates, and follow-up completion. This enables leadership to assess the effectiveness of sales processes and customer outreach across the group.
Marketing and Advertising ROI: These reports evaluate the performance of marketing campaigns across the group, showing cost per lead, conversion rates by source, ad spend efficiency, and brand engagement. They help optimize marketing investments and align them with dealership-level sales results.
Compliance and Operational Auditing: Group-level BI reporting may also include compliance metrics such as open recalls, documentation completeness, finance compliance flags, and process adherence scores. These ensure that uniform standards are met across all stores and brands.
Cross-Store Benchmarking and Trend Analysis: One of the greatest values of dealer group BI reporting is the ability to benchmark performance across multiple rooftops. This includes comparing KPIs between stores, brands, or regions, and identifying high-performing practices that can be replicated elsewhere.

In summary, dealer group-level business intelligence reporting may bring together data from across the enterprise to provide a unified view of operations, sales, service, marketing, and finance. It supports strategic oversight by enabling leaders to identify trends, monitor consistency, spot growth opportunities, and take corrective action where needed, thus ensuring that all dealerships in the group are aligned with performance goals and organizational standards.

### Concept 2:

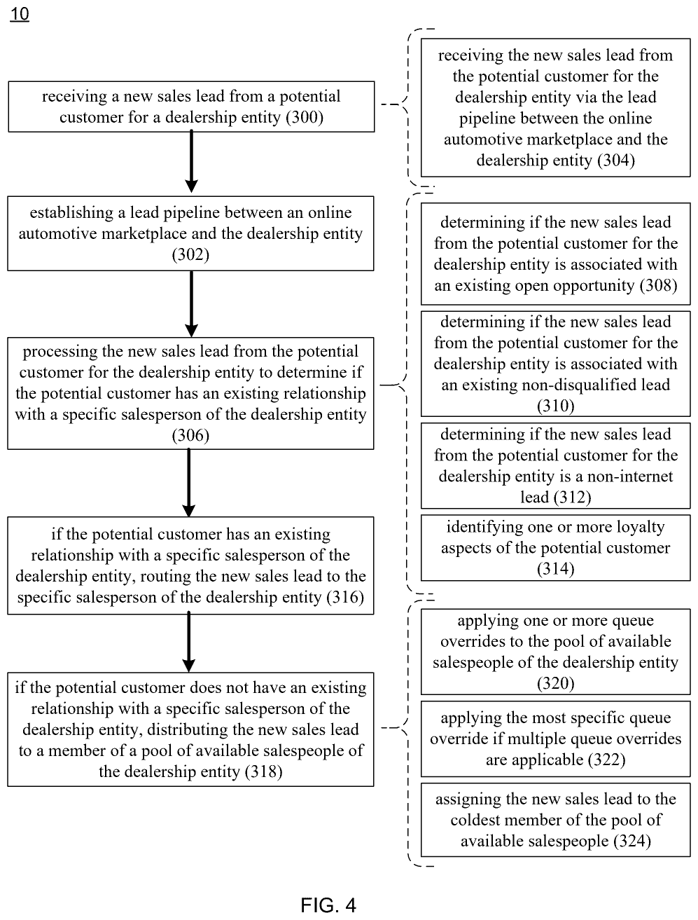

Referring also to FIG. 4, information management process 10 may receive 300 a new sales lead (e.g., new sales lead 108) from a potential customer (e.g., potential customer 110) for a dealership entity (e.g., dealership entity 112).

Such a new sales lead (e.g., new sales lead 108) from a potential customer (e.g., potential customer 110) for a specific dealership entity (e.g., dealership entity 112) within the dealership group (e.g., dealership group 114) may be any type of sales lead, examples of which may include but are not limited to: an internet-based sales lead, a physical (e.g., walk-in) sales lead; and a telephone-based sales lead.

The dealership entity (e.g., dealership entity 112) may be one of a plurality of dealership entities (e.g., plurality of dealership entities 124) associated with a dealership group (e.g., dealership group 114).

The structure of a dealership group (e.g., dealership group 114) is a hierarchical business organization in which a parent company or corporate entity owns, operates, or manages multiple vehicle dealership entities (e.g., plurality of dealership entities 124), often across brand franchises. Each individual dealership entity within the dealership group (e.g., dealership group 114) may function as a distinct business unit (frequently referred to as a “rooftop”) but is connected through shared ownership, centralized leadership, and standardized processes set by the dealership group (e.g., dealership group 114).

At the top level is the dealer group headquarters, which may be responsible for corporate strategy, executive leadership, financial management, technology infrastructure, legal and compliance oversight, and high-level manufacturer relations. This central office may house departments such as marketing, human resources, accounting, IT, and business development that serve the entire group. The dealership group (e.g., dealership group 114) may be privately held, publicly traded, or part of a larger conglomerate.

Beneath the group level are the individual dealership entities, each with its own management structure, such as a general manager, sales manager, service manager, and finance team. These dealerships may represent one or more OEM brands (e.g., Ford, Toyota, BMW) and are usually licensed to sell and service vehicles under those brand names. While day-to-day operations (e.g., sales interactions, service appointments, and parts orders) may be managed locally, each dealership may align with the group's overarching business standards, technology platforms (like shared CRM and DMS systems), and performance expectations.

This structure may enable dealership groups (e.g., dealership group 114) to benefit from economies of scale, such as bulk purchasing of advertising or software, shared marketing strategies, group-level inventory balancing, and coordinated employee training. At the same time, each dealership may maintain the flexibility to adapt to its local market, customer demographics, and brand-specific requirements.

In summary, a dealership group (e.g., dealership group 114) may consist of a centralized parent organization overseeing multiple, separately operating dealerships, each of which manages its own local operations but contributes to and benefits from the resources, strategy, and leadership of the broader group. This structure may enable growth, consistency, and operational efficiency across a distributed dealership network.

The dealership entity (e.g., dealership entity 112) may be a vehicle dealership entity (e.g., dealership entity 112). Accordingly, the dealership entity (e.g., dealership entity 112) may sell e.g., automobiles, light duty trucks, heavy duty trucks, heavy equipment, motorcycles, off road vehicles, airplanes, boats, etc.

Information management process 10 may establish 302 a lead pipeline (e.g., lead pipeline 126) between an online automotive marketplace (e.g., online automotive marketplace 128) and the dealership entity (e.g., dealership entity 112).

A lead pipeline (e.g., lead pipeline 126) between an online automotive marketplace (e.g., online automotive marketplace 128) and a dealership entity (e.g., dealership entity 112) may refer to the digital process through which consumer interest generated on a third-party marketplace website (e.g., Autotrader, Cars.com, Edmunds, or CarGurus) is captured, transmitted, and managed by the dealership's sales system, often through a CRM platform (e.g., generic CRM platform 102).

Such a lead pipeline may perform as follows:
Lead Generation on the Marketplace: A potential car buyer may visit an online automotive marketplace (e.g., online automotive marketplace 128) and view listings for vehicles. These listings may include new and used inventory uploaded by multiple dealerships. When a shopper expresses interest (e.g., by filling out a contact form, requesting a quote, scheduling a test drive, or clicking a “call the dealer” button), a sales lead (e.g., new sales lead 108) may be generated.
Lead Capture and Transmission: The customer's inquiry (including their contact information, vehicle of interest, and any notes or questions) may be electronically transmitted from the marketplace (e.g., online automotive marketplace 128) to the corresponding dealership. This may be done via e.g., an API, lead integration feed, or a third-party lead distribution platform (e.g., a lead aggregator or digital retailing tool).
Lead Intake and Assignment at the Dealership: Once the lead (e.g., new sales lead 108) enters the dealership's CRM (e.g., generic CRM platform 102), it is timestamped, logged, and assigned to a salesperson or internet sales team. The CRM (e.g., generic CRM platform 102) may include automation to classify the lead (e.g., hot, warm, cold), assign follow-up tasks, and trigger auto-responses or reminders. The lead may also be enriched with data (e.g., the customer's browsing behavior, location, or trade-in interest).
Sales Process and Engagement: A salesperson may follow up with the lead through phone, email, or text, often using templated responses and scripts within the CRM (e.g., generic CRM platform 102). Throughout this process, every touchpoint may be recorded within the CRM (e.g., generic CRM platform 102), enabling future analysis and follow-up.
Reporting and Feedback Loop: The dealership may monitor lead performance metrics such as response time, engagement rate, appointment set rate, and close ratio. KPI reports may help evaluate both sales staff effectiveness and the lead quality from each marketplace.

A lead pipeline between an online automotive marketplace (e.g., online automotive marketplace 128) and a dealership entity (e.g., dealership entity 112) may be a critical digital sales pathway, which starts with a consumer expressing interest online and ends with that inquiry being handled/tracked/followed up within the dealership's systems.

When receiving 300 a new sales lead (e.g., new sales lead 108) from a potential customer (e.g., potential customer 110) for a dealership entity (e.g., dealership entity 112), information management process 10 may receive 304 the new sales lead (e.g., new sales lead 108) from the potential customer (e.g., potential customer 110) for the dealership entity (e.g., dealership entity 112) via the lead pipeline (e.g., lead pipeline 126) between the online automotive marketplace (e.g., online automotive marketplace 128) and the dealership entity (e.g., dealership entity 112).

Specifically and for this example, assume that such a new sales lead 108) from the potential customer (e.g., potential customer 110) may request information concerning a specific vehicle (e.g., a Ford F-150 pickup truck) available via the specific dealership entity (e.g., dealership entity 112).

Information management process 10 may process 306 the new sales lead (e.g., new sales lead 108) from the potential customer (e.g., potential customer 110) for the dealership entity (e.g., dealership entity 112) to determine if the potential customer (e.g., potential customer 110) has an existing relationship with a specific salesperson of the dealership entity (e.g., dealership entity 112).

Continuing with the above-stated example, assume again that the potential customer (e.g., potential customer 110) is John Smith of 1 Main Street in San Jose, California, who has a mobile phone number of 123-456-7890.

When processing 306 new sales lead 108 from potential customer 110 for dealership entity 112 to determine if potential customer 110 has an existing relationship with a specific salesperson of dealership entity 112, information management process 10 may research various aspects of new sales lead 108 to determine the manner in which new sales lead 108 should be routed.

For example and when processing 306 the new sales lead (e.g., new sales lead 108) from the potential customer (e.g., potential customer 110) for the dealership entity (e.g., dealership entity 112) to determine if the potential customer (e.g., potential customer 110) has an existing relationship with a specific salesperson of the dealership entity (e.g., dealership entity 112), information management process 10 may determine 308 if the new sales lead (e.g., new sales lead 108) from the potential customer (e.g., potential customer 110) for the dealership entity (e.g., dealership entity 112) is associated with an existing open opportunity.

An open opportunity in a dealership refers to a sales prospect or customer lead that has been identified but not yet closed or resolved, meaning the potential sale, lease, or service transaction is still in progress. An open opportunity typically represents a customer who has shown interest in a vehicle or service but has not yet completed a purchase, signed paperwork, or otherwise exited the sales funnel. These open opportunities are often actively tracked within the dealership's CRM system or Dealer Management System as part of the sales pipeline.

For example, if a customer submits an inquiry through an online marketplace, schedules a test drive, or visits the showroom but hasn't yet committed to buying, that scenario is recorded as an open opportunity. Sales staff are usually assigned to these opportunities, with follow-up tasks, communication history, and progress stages (e.g., contacted, appointment set, demo completed) logged and updated in real time. The dealership monitors open opportunities to prioritize follow-ups, improve conversion rates, and reduce lost sales.

In short, an open opportunity may be a valuable, active lead that represents a potential sale or service engagement still being worked by the dealership, and it is a key focus of daily sales operations.

Accordingly, information management process 10 may search within the Dealer Management System (e.g., DMS 106) and the Customer Relationship Management platforms (e.g., generic CRM platform 102) to determine if (in this example) John Smith of 1 Main Street in San Jose, California, having a mobile phone number of 123-456-7890 is an open opportunity, in that they are in the Dealer Management System (e.g., DMS 106) and the Customer Relationship Management platform (e.g., generic CRM platform 102) as a sales prospect or customer lead that has been identified but not yet closed or resolved.

Additionally and when processing 306 the new sales lead (e.g., new sales lead 108) from the potential customer (e.g., potential customer 110) for the dealership entity (e.g., dealership entity 112) to determine if the potential customer (e.g., potential customer 110) has an existing relationship with a specific salesperson of the dealership entity (e.g., dealership entity 112), information management process 10 may determine 310 if the new sales lead (e.g., new sales lead 108) from the potential customer (e.g., potential customer 110) for the dealership entity (e.g., dealership entity 112) is associated with an existing non-disqualified lead.

A non-disqualified lead in a dealership context may refer to a sales lead or customer inquiry that remains active and viable, meaning it has not been ruled out or marked as ineligible for further sales follow-up. In other words, the lead has not been “disqualified” based on typical filtering criteria such as incorrect contact information, lack of buying intent, budget misalignment, or ineligibility for financing. Non-disqualified leads are considered open and actionable opportunities. They are often still in the early or mid stages of the sales funnel, such as “contacted,” “interested,” or “appointment scheduled”, and are subject to ongoing engagement by sales staff. These leads are logged and tracked in the dealership's CRM platform, where they can be assigned tasks, follow-up reminders, or included in automated marketing workflows. The distinction between a non-disqualified and a disqualified lead is important for dealership performance metrics, as non-disqualified leads are counted in key indicators such as lead volume, conversion rates, and opportunity pipelines. Managing and nurturing these leads effectively may be crucial to maximizing the dealership's overall sales performance and customer retention.

Accordingly, information management process 10 may search within the Dealer Management System (e.g., DMS 106) and the Customer Relationship Management platforms (e.g., generic CRM platform 102) to determine if (in this example) John Smith of 1 Main Street in San Jose, California, having a mobile phone number of 123-456-7890 is a non-disqualified lead, in that they are in the Dealer Management System (e.g., DMS 106) and the Customer Relationship Management platforms (e.g., generic CRM platform 102) as a sales lead or customer inquiry that remains active and viable, in that it has not been ruled out or marked as ineligible for further sales follow-up

Further and when processing 306 the new sales lead (e.g., new sales lead 108) from the potential customer (e.g., potential customer 110) for the dealership entity (e.g., dealership entity 112) to determine if the potential customer (e.g., potential customer 110) has an existing relationship with a specific salesperson of the dealership entity (e.g., dealership entity 112), information management process 10 may determine 312 if the new sales lead (e.g., new sales lead 108) from the potential customer (e.g., potential customer 110) for the dealership entity (e.g., dealership entity 112) is a non-internet lead.

A non-internet lead in a dealership context may refer to a customer inquiry or sales opportunity that originates from an offline or non-digital source (as opposed to the internet or online platforms). These leads come from traditional, in-person, or phone-based channels and are often generated through walk-ins, referrals, phone calls, direct mail responses, on-site events, or repeat service visits. For example, a customer who walks into the showroom without first submitting an online form, or someone who calls the dealership after seeing a TV ad or a billboard, would be considered a non-internet lead. Similarly, customers returning for service or those referred by a friend or family member typically fall into this category. These leads are usually entered manually into the dealership's Dealer Management System (e.g., DMS 106) and the Customer Relationship Management platforms (e.g., generic CRM platform 102), where they are tracked and managed alongside internet leads. Non-internet leads are important because they often represent high-intent buyers (particularly walk-ins) who are further along in the decision-making process. Dealerships often analyze the performance of internet vs. non-internet leads separately to better understand sales effectiveness, lead source ROI, and customer behavior across different channels.

Accordingly, information management process 10 may search within the Dealer Management System (e.g., DMS 106) and the Customer Relationship Management platforms (e.g., generic CRM platform 102) to determine if (in this example) John Smith of 1 Main Street in San Jose, California, having a mobile phone number of 123-456-7890 is a non-internet lead, in that physically visited the dealership or called the dealership. Information management process 10 may make such a determination because non-internet leads are often already associated with (assigned to) a salesperson, as calls and visits to the dealership are usually immediately routed to an available salesperson.

Additionally and when processing 306 the new sales lead (e.g., new sales lead 108) from the potential customer (e.g., potential customer 110) for the dealership entity (e.g., dealership entity 112) to determine if the potential customer (e.g., potential customer 110) has an existing relationship with a specific salesperson of the dealership entity (e.g., dealership entity 112), information management process 10 may identify 314 one or more loyalty aspects of the potential customer (e.g., potential customer 110).

Examples of such loyalty aspects may include but are not limited to being a repeat customer. For example, was John Smith of 1 Main Street in San Jose, California, having a mobile phone number of 123-456-7890 a previous customer of salesperson Linda Graham? In other words, did Linda Graham previously sell a vehicle to John Smith. If so, information management process 10 may identify 314 this previous successful sale as a loyalty aspect of the potential customer (e.g., potential customer 110).

### When an Existing Relationship Exists:

Information management process 10 may route 316 the new sales lead (e.g., new sales lead 108) to the specific salesperson of the dealership entity (e.g., dealership entity 112) if the potential customer (e.g., potential customer 110) has an existing relationship with a specific salesperson of the dealership entity (e.g., dealership entity 112).

For example, assume that John Smith of 1 Main Street in San Jose, California, having a mobile phone number of 123-456-7890 has an existing relationship with a salesperson (e.g., Susan Thompson) within the dealership (e.g., John Smith is an open opportunity for Susan Thompson, an existing non-disqualified lead of Susan Thompson or a repeat customer of Susan Thompson). Accordingly, information management process 10 may route 316 the new sales lead (e.g., new sales lead 108) to Susan Thompson within the dealership entity (e.g., dealership entity 112), since the potential customer (e.g., potential customer 110) has an existing relationship with Susan Thompson.

When an Existing Relationship does not Exist:

Information management process 10 may distribute 318 the new sales lead (e.g., new sales lead 108) to a member of a pool of available salespeople of the dealership entity (e.g., dealership entity 112) if the potential customer (e.g., potential customer 110) does not have an existing relationship with a specific salesperson of the dealership entity (e.g., dealership entity 112).

For example, assume that John Smith of 1 Main Street in San Jose, California, having a mobile phone number of 123-456-7890 has no existing relationship with a salesperson within the dealership (e.g., John Smith is not an open opportunity of any salesperson, is not an existing non-disqualified lead of any salesperson and is not a repeat customer of any salesperson). Accordingly, information management process 10 may distribute 318 the new sales lead (e.g., new sales lead 108) to a member of a pool of available salespeople (e.g., sales pool 130) of the dealership entity (e.g., dealership entity 112) since the potential customer (e.g., potential customer 110) does not have an existing relationship with a specific salesperson of the dealership entity (e.g., dealership entity 112).

For example and when distributing 318 the new sales lead (e.g., new sales lead 108) to a member of a pool of available salespeople (e.g., sales pool 130) of the dealership entity (e.g., dealership entity 112), information management process 10 may:
apply 320 one or more queue overrides to the pool of available salespeople (e.g., sales pool 130) of the dealership entity (e.g., dealership entity 112);
apply 322 the most specific queue override if multiple queue overrides are applicable; and/or
assign 324 the new sales lead (e.g., new sales lead 108) to the coldest member of the pool of available salespeople (e.g., sales pool 130).

For example and when applying 320 one or more queue overrides to the pool of available salespeople (e.g., sales pool 130) of the dealership entity (e.g., dealership entity 112), information management process 10 may apply 320 a queue override to e.g., direct the new sales lead (e.g., new sales lead 108) to the winner of a sales contest, direct the new sales lead (e.g., new sales lead 108) to a leading salesperson, or direct the new sales lead (e.g., new sales lead 108) to a high seniority salesperson.

Additionally and when applying 322 the most specific queue override if multiple queue overrides are applicable, information management process 10 may apply 322 the most applicable (or most beneficial) queue override in the event that multiple queue overrides are available. For example, if salesperson John Dean is the winner of a sales contest, a leading salesperson, and a high seniority salesperson, information management process 10 may apply any one of these overrides. For example, information management process 10 may select and apply the override that is the most beneficial to salesperson John Dean and assign the new sales lead (e.g., new sales lead 108) to John Dean.

Further and when assigning 324 the new sales lead (e.g., new sales lead 108) to the coldest member of the pool of available salespeople (e.g., sales pool 130), information management process 10 may assign 324 the new sales lead (e.g., new sales lead 108) to the member of the pool of available salespeople (e.g., sales pool 130) that has gone the longest period without receiving a new sales lead.

### Concept 3:

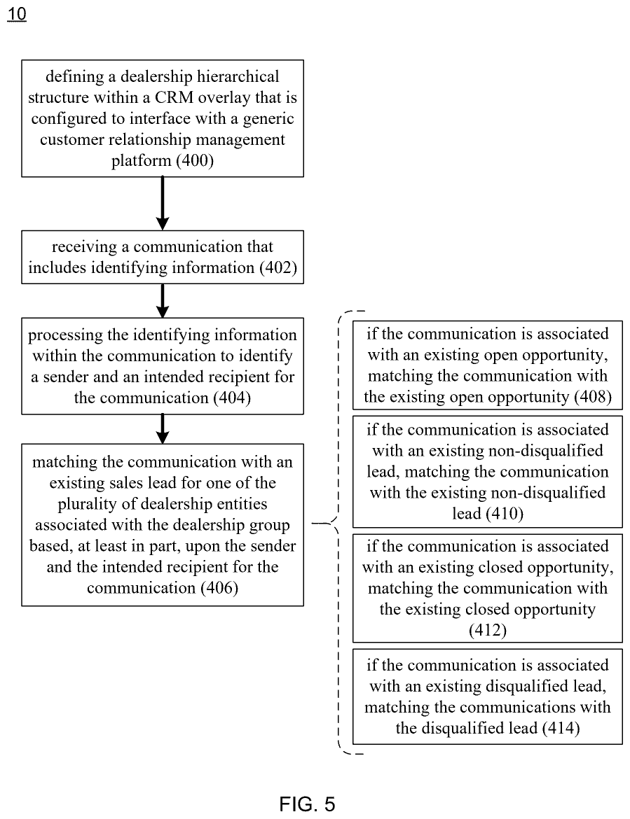

Referring also to FIG. 5, information management process 10 may define 400 a dealership hierarchical structure (e.g., dealership hierarchical structure 104) within a CRM overlay (e.g., CRM overlay 100) that is configured to interface with a generic customer relationship management platform (e.g., generic CRM platform 102). The dealership hierarchical structure (e.g., dealership hierarchical structure 104) may identify a plurality of dealership entities (e.g., plurality of dealership entities 124) associated with a dealership group (e.g., dealership group 114).

As discussed above, a dealership hierarchical structure (e.g., dealership hierarchical structure 104) may identify a plurality of dealership entities (e.g., a plurality of vehicle dealership entities) associated with a dealership group (e.g., a vehicle dealership group). A dealership hierarchical structure (e.g., dealership hierarchical structure 104) may represent an organized, multi-level arrangement in which multiple independently operating dealerships are managed under a central, parent organization. This structure is common in the automotive retail industry, where large dealership groups own and oversee several dealership locations, each potentially representing different brands, geographic areas, or customer markets.

The CRM overlay (e.g., CRM overlay 100) may include a dealer CRM solution that runs on top of and/or interfaces with the generic customer relationship management platform (e.g., generic CRM platform 102). As discussed above, a CRM overlay (e.g., CRM overlay 100) in the context of a vehicle dealership refers to an add-on interface, toolset, or layer of functionality that integrates with the dealership's existing CRM platform (e.g., generic CRM platform 102) to enhance or customize its capabilities. Rather than replacing the core CRM platform (e.g., generic CRM platform 102), a CRM overlay (e.g., CRM overlay 100) works on top of it, adding features such as automation, lead scoring, workflow enhancements, data enrichment, or improved user interfaces tailored specifically to dealership needs.

Information management process 10 may receive 402 a communication (e.g., communication 132) that includes identifying information (e.g., identifying information 134). This identifying information (e.g., identifying information 134) included within the communication (e.g., communication 132) may include one or more of: a telephone number and an email address.

Examples of this communication (e.g., communication 132) may include but are not limited to one or more of: an SMS-based communication; an email-based communication; and a voice-based communication.

In a dealership CRM platform (e.g., generic CRM platform 102), communication with customers may happen through multiple channels, the three most common types being SMS-based communication, email-based communication, and voice-based communication, wherein each of these communication methodologies plays an important role in customer engagement, lead nurturing, and sales follow-up.

SMS-Based Communication: SMS-based communication may refer to text messages sent and received between dealership staff and customers. These messages may be short, timely, and direct, making them ideal for appointment confirmations, quick updates, reminders, or follow-ups. The CRM platform (e.g., generic CRM platform 102) may offer SMS integration that allows SMS messages to be received directly on and/or sent directly from the platform (e.g., generic CRM platform 102), either manually by a salesperson or automatically through workflows (e.g., sending a service reminder 24 hours before an appointment). SMS messages may be time-stamped and attached to a customer's profile, creating a record of the conversation.

Email-Based Communication: Email-based communication may involve sending personalized or automated emails to customers for purposes such as lead follow-up, promotional offers, service updates, or customer satisfaction surveys. The CRM platform (e.g., generic CRM platform 102) may offer email integration that may allow email to be received directly on and/or sent directly from the CRM platform (e.g., generic CRM platform 102) using pre-built templates and/or custom messages. The CRM platform (e.g., generic CRM platform 102) may track open rates, click-throughs, replies, and bouncebacks, which may be logged in the customer's communication history, creating a record of the conversation. Campaign tools within the CRM platform (e.g., generic CRM platform 102) may also segment customers and send mass emails for marketing purposes, while also providing analytics on engagement levels.

Voice-Based Communication: Voice-based communication may refer to phone calls between dealership staff and customers, whether incoming or outgoing, that are tracked or initiated through the CRM platform (e.g., generic CRM platform 102). The CRM platform (e.g., generic CRM platform 102) may offer telephony integration, allowing sales or service staff to place calls directly from the system (click-to-call) or log external calls manually. Advanced systems may also record calls, transcribe conversations, or note the call's outcome (e.g., left voicemail, spoke to customer, set appointment). Voice communication logs may help ensure that every call attempt or discussion is documented and contributes to the overall sales or service history of the customer.

Each type of communication (e.g., SMS, email, and voice) serves a unique purpose in the dealership-customer relationship, and when integrated with the CRM platform (e.g., generic CRM platform 102), they may provide a complete, timestamped history of interactions. This enables dealership staff to maintain continuity in communication, personalize future outreach, and measure engagement effectiveness; ultimately improving customer satisfaction and conversion rates.

Information management process 10 may process 404 the identifying information (e.g., identifying information 134) within the communication (e.g., communication 132) to identify a sender and an intended recipient for the communication (e.g., communication 132), wherein one of the sender and the intended recipient may be a professional at one of the plurality of dealership entities (e.g., plurality of dealership entities 124) associated with the dealership group (e.g., dealership group 114). Examples of such a professional may include but is not limited to a salesperson/service person/parts person/finance person/manager/owner at one of the plurality of dealership entities (e.g., plurality of dealership entities 124) associated with the dealership group (e.g., dealership group 114).

As discussed above, this identifying information (e.g., identifying information 134) included within the communications (e.g., communication 132) may include one or more of: a telephone number and an email address. Specifically and as discussed above, examples of these communications (e.g., communication 132) may include: an SMS-based communication; an email-based communication; and a voice-based communication. Therefore, the sender and/or intended recipient of the communication (e.g., communication 132) may be defined via a cell phone number (for SMS-based communication), an email address (for email-based communication) and a phone number (for voice-based communication).

Accordingly and when processing 404 the identifying information (e.g., identifying information 134) within the communication (e.g., communication 132) to identify a sender and an intended recipient for the communication (e.g., communication 132), information management process 10 may attempt to associate the cell phone numbers (for SMS-based communication), the email addresses (for email-based communication) and the phone numbers (for voice-based communication) defined within the communication (e.g., communication 132) with various employment records defined for the plurality of dealership entities (e.g., plurality of dealership entities 124) and/or the dealership group (e.g., dealership group 114). Therefore, once a cell phone number, an email address or a phone number defined within communication 132 can be associated with an employee of the dealership entities (e.g., plurality of dealership entities 124) and/or the dealership group (e.g., dealership group 114), the sender and the intended recipient for the communication (e.g., communication 132), as well as the direction of the communication (e.g., communication 132), may be identified.

Information management process 10 may match 406 the communication (e.g., communication 132) with an existing sales lead for one of the plurality of dealership entities (e.g., plurality of dealership entities 124) associated with the dealership group (e.g., dealership group 114) based, at least in part, upon the sender and the intended recipient for the communication (e.g., communication 132).

As will be discussed below in greater detail, the manner in which information management process 10 may match 406 the communication (e.g., communication 132) with an existing sales lead for one of the plurality of dealership entities (e.g., plurality of dealership entities 124) associated with the dealership group (e.g., dealership group 114) based, at least in part, upon the sender and the intended recipient for the communication (e.g., communication 132) may be accomplished in a variety of ways.

For example and when matching 406 the communication (e.g., communication 132) with an existing sales lead for one of the plurality of dealership entities (e.g., plurality of dealership entities 124) associated with a dealership group (e.g., dealership group 114) based, at least in part, upon the sender and the intended recipient for the communication, information management process 10 may match 408 the communication (e.g., communication 132) with an existing open opportunity if the communication (e.g., communication 132) is associated with the existing open opportunity.

As discussed above, an existing open opportunity in a dealership may refer to a sales prospect or customer lead that has been identified but not yet closed or resolved, meaning the potential sale, lease, or service transaction is still in progress. An open opportunity typically represents a customer who has shown interest in a vehicle or service but has not yet completed a purchase, signed paperwork, or otherwise exited the sales funnel. These open opportunities are often actively tracked within the dealership's CRM system or Dealer Management System as part of the sales pipeline.

Once the cell phone number, email address or phone number defined within communication 132 is associated with an employee of the dealership entities (e.g., plurality of dealership entities 124) and/or the dealership group (e.g., dealership group 114), the sender/intended recipient of communication 132 may be identified, thus enabling information management process 10 to match 408 communication 132 with the above-referenced existing open opportunity if the identified sender/intended recipient is associated with this existing open opportunity.

Further and when matching 406 the communication (e.g., communication 132) with an existing sales lead for one of the plurality of dealership entities (e.g., plurality of dealership entities 124) associated with a dealership group (e.g., dealership group 114) based, at least in part, upon the sender and the intended recipient for the communication, information management process 10 may match 410 the communication (e.g., communication 132) with an existing non-disqualified lead if the communication (e.g., communication 132) is associated with the existing non-disqualified lead.

As discussed above, an existing non-disqualified lead in a dealership context may refer to a sales lead or customer inquiry that remains active and viable, meaning it has not been ruled out or marked as ineligible for further sales follow-up. In other words, the lead has not been “disqualified” based on typical filtering criteria such as incorrect contact information, lack of buying intent, budget misalignment, or ineligibility for financing. Non-disqualified leads are considered open and actionable opportunities. They are often still in the early or mid stages of the sales funnel, such as “contacted,” “interested,” or “appointment scheduled”, and are subject to ongoing engagement by sales staff. These leads are logged and tracked in the dealership's CRM platform, where they can be assigned tasks, follow-up reminders, or included in automated marketing workflows.

Once the cell phone number, email address or phone number defined within communication 132 is associated with an employee of the dealership entities (e.g., plurality of dealership entities 124) and/or the dealership group (e.g., dealership group 114), the sender/intended recipient of communication 132 may be identified, thus enabling information management process 10 to match 410 communication 132 with the above-referenced existing non-disqualified lead if the identified sender/intended recipient is associated with this existing non-disqualified lead.

Additionally and when matching 406 the communication (e.g., communication 132) with an existing sales lead for one of the plurality of dealership entities (e.g., plurality of dealership entities 124) associated with a dealership group (e.g., dealership group 114) based, at least in part, upon the sender and the intended recipient for the communication, information management process 10 may match 412 the communication (e.g., communication 132) with an existing closed opportunity if the communication (e.g., communication 132) is associated with the existing closed opportunity.

An existing closed opportunity in a dealership may refer to a sales or service opportunity that has been fully resolved or completed and is already recorded in the dealership's CRM or DMS as closed. Accordingly, the customer journey related to that specific opportunity has ended, either because the vehicle was sold, the service was performed, or the customer declined and is no longer considered active for that particular engagement. There are typically two main types of closed opportunities:
Closed-Won: The customer completed the transaction, such as purchasing or leasing a vehicle, finalizing F&I products, or completing a service appointment. This is a successful outcome for the dealership.
Closed-Lost: The customer did not proceed with the transaction for various reasons, such as buying from another dealership, deciding not to purchase, or becoming unresponsive. This still marks the end of that specific opportunity, though the customer may remain in the database for future engagement.

Once the cell phone number, email address or phone number defined within communication 132 is associated with an employee of the dealership entities (e.g., plurality of dealership entities 124) and/or the dealership group (e.g., dealership group 114), the sender/intended recipient of communication 132 may be identified, thus enabling information management process 10 to match 412 communication 132 with the above-referenced existing closed opportunity if the identified sender/intended recipient is associated with this existing closed opportunity.

Further and when matching 406 the communication (e.g., communication 132) with an existing sales lead for one of the plurality of dealership entities (e.g., plurality of dealership entities 124) associated with a dealership group (e.g., dealership group 114) based, at least in part, upon the sender and the intended recipient for the communication (e.g., communication 132), information management process 10 may match 414 the communication (e.g., communication 132) with an existing disqualified lead if the communication is associated with the existing disqualified lead.

An existing disqualified lead in a dealership context may refer to a potential customer or sales prospect that has been evaluated and determined to no longer be a viable opportunity for follow-up or conversion. This status is typically set within the dealership's CRM platform (e.g., generic CRM platform 102) when the lead fails to meet certain criteria or cannot proceed through the sales or service funnel.

Common reasons for disqualifying a lead may include: invalid contact information (e.g., fake email or phone number); no intent to purchase or engage (e.g., the lead was just browsing or clearly uninterested); out-of-market location (e.g., the customer is too far away from the dealership to be realistically served); financial ineligibility (e.g., not approved for financing and unable to proceed); duplicate or already served (e.g., the lead was already handled under another name or profile); and customer purchased elsewhere. When a lead is disqualified, the lead may be marked accordingly in the CRM platform (e.g., generic CRM platform 102), typically removed from active sales pipelines, and excluded from ongoing follow-ups or automated marketing efforts. However, the lead record may often be retained for historical reference and future re-evaluation if circumstances change.

Once the cell phone number, email address or phone number defined within communication 132 is associated with an employee of the dealership entities (e.g., plurality of dealership entities 124) and/or the dealership group (e.g., dealership group 114), the sender/intended recipient of communication 132 may be identified, thus enabling information management process 10 to match 414 communication 132 with the above-referenced existing disqualified lead if the identified sender/intended recipient is associated with this existing disqualified lead.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving a new sales lead from a potential customer for a dealership entity;
processing the new sales lead from the potential customer for the dealership entity to determine if the potential customer has an existing relationship with a specific salesperson of the dealership entity;
if the potential customer has an existing relationship with a specific salesperson of the dealership entity, routing the new sales lead to the specific salesperson of the dealership entity; and
if the potential customer does not have an existing relationship with a specific salesperson of the dealership entity, distributing the new sales lead to a member of a pool of available salespeople of the dealership entity.

2. The computer-implemented method of claim 1 further comprising:
establishing a lead pipeline between an online automotive marketplace and the dealership entity.

3. The computer-implemented method of claim 2 wherein receiving a new sales lead from a potential customer for a dealership entity includes:
receiving the new sales lead from the potential customer for the dealership entity via the lead pipeline between the online automotive marketplace and the dealership entity.

4. The computer-implemented method of claim 2 wherein the dealership entity is one of a plurality of dealership entities associated with a dealership group.

5. The computer-implemented method of claim 1 wherein the dealership entity is a vehicle dealership entity.

6. The computer-implemented method of claim 1 wherein processing the new sales lead from the potential customer for the dealership entity to determine if the potential customer has an existing relationship with a specific salesperson of the dealership entity includes:
determining if the new sales lead from the potential customer for the dealership entity is associated with an existing open opportunity.

7. The computer-implemented method of claim 6 wherein processing the new sales lead from the potential customer for the dealership entity to determine if the potential customer has an existing relationship with a specific salesperson of the dealership entity includes:
determining if the new sales lead from the potential customer for the dealership entity is associated with an existing non-disqualified lead.

8. The computer-implemented method of claim 7 wherein processing the new sales lead from the potential customer for the dealership entity to determine if the potential customer has an existing relationship with a specific salesperson of the dealership entity includes:
determining if the new sales lead from the potential customer for the dealership entity is a non-internet lead.

9. The computer-implemented method of claim 8 wherein processing the new sales lead from the potential customer for the dealership entity to determine if the potential customer has an existing relationship with a specific salesperson of the dealership entity includes:
identifying one or more loyalty aspects of the potential customer.

10. The computer-implemented method of claim 1 wherein distributing the new sales lead to a member of a pool of available salespeople of the dealership entity includes one or more of:
applying one or more queue overrides to the pool of available salespeople of the dealership entity;
applying the most specific queue override if multiple queue overrides are applicable; and
assigning the new sales lead to the coldest member of the pool of available salespeople.

11. A computer program product residing on a computer readable medium having a plurality of instructions stored thereon which, when executed by a processor, cause the processor to perform operations comprising:
receiving a new sales lead from a potential customer for a dealership entity;
processing the new sales lead from the potential customer for the dealership entity to determine if the potential customer has an existing relationship with a specific salesperson of the dealership entity;
if the potential customer has an existing relationship with a specific salesperson of the dealership entity, routing the new sales lead to the specific salesperson of the dealership entity; and
if the potential customer does not have an existing relationship with a specific salesperson of the dealership entity, distributing the new sales lead to a member of a pool of available salespeople of the dealership entity.

12. The computer program product of claim 11 further comprising:
establishing a lead pipeline between an online automotive marketplace and the dealership entity.

13. The computer program product of claim 12 wherein receiving a new sales lead from a potential customer for a dealership entity includes:
receiving the new sales lead from the potential customer for the dealership entity via the lead pipeline between the online automotive marketplace and the dealership entity.

14. The computer program product of claim 12 wherein the dealership entity is one of a plurality of dealership entities associated with a dealership group.

15. The computer program product of claim 11 wherein the dealership entity is a vehicle dealership entity.

16. The computer program product of claim 11 wherein processing the new sales lead from the potential customer for the dealership entity to determine if the potential customer has an existing relationship with a specific salesperson of the dealership entity includes:
determining if the new sales lead from the potential customer for the dealership entity is associated with an existing open opportunity.

17. The computer program product of claim 16 wherein processing the new sales lead from the potential customer for the dealership entity to determine if the potential customer has an existing relationship with a specific salesperson of the dealership entity includes:
determining if the new sales lead from the potential customer for the dealership entity is associated with an existing non-disqualified lead.

18. The computer program product of claim 17 wherein processing the new sales lead from the potential customer for the dealership entity to determine if the potential customer has an existing relationship with a specific salesperson of the dealership entity includes:
determining if the new sales lead from the potential customer for the dealership entity is a non-internet lead.

19. The computer program product of claim 18 wherein processing the new sales lead from the potential customer for the dealership entity to determine if the potential customer has an existing relationship with a specific salesperson of the dealership entity includes:
identifying one or more loyalty aspects of the potential customer.

20. The computer program product of claim 11 wherein distributing the new sales lead to a member of a pool of available salespeople of the dealership entity includes one or more of:
applying one or more queue overrides to the pool of available salespeople of the dealership entity;
applying the most specific queue override if multiple queue overrides are applicable; and
assigning the new sales lead to the coldest member of the pool of available salespeople.

21. A computing system including a processor and memory configured to perform operations comprising:
receiving a new sales lead from a potential customer for a dealership entity;
processing the new sales lead from the potential customer for the dealership entity to determine if the potential customer has an existing relationship with a specific salesperson of the dealership entity;
if the potential customer has an existing relationship with a specific salesperson of the dealership entity, routing the new sales lead to the specific salesperson of the dealership entity; and
if the potential customer does not have an existing relationship with a specific salesperson of the dealership entity, distributing the new sales lead to a member of a pool of available salespeople of the dealership entity.

22. The computing system of claim 21 further comprising:
establishing a lead pipeline between an online automotive marketplace and the dealership entity.

23. The computing system of claim 22 wherein receiving a new sales lead from a potential customer for a dealership entity includes:
receiving the new sales lead from the potential customer for the dealership entity via the lead pipeline between the online automotive marketplace and the dealership entity.

24. The computing system of claim 22 wherein the dealership entity is one of a plurality of dealership entities associated with a dealership group.

25. The computing system of claim 21 wherein the dealership entity is a vehicle dealership entity.

26. The computing system of claim 21 wherein processing the new sales lead from the potential customer for the dealership entity to determine if the potential customer has an existing relationship with a specific salesperson of the dealership entity includes:
determining if the new sales lead from the potential customer for the dealership entity is associated with an existing open opportunity.

27. The computing system of claim 26 wherein processing the new sales lead from the potential customer for the dealership entity to determine if the potential customer has an existing relationship with a specific salesperson of the dealership entity includes:
determining if the new sales lead from the potential customer for the dealership entity is associated with an existing non-disqualified lead.

28. The computing system of claim 27 wherein processing the new sales lead from the potential customer for the dealership entity to determine if the potential customer has an existing relationship with a specific salesperson of the dealership entity includes:
determining if the new sales lead from the potential customer for the dealership entity is a non-internet lead.

29. The computing system of claim 28 wherein processing the new sales lead from the potential customer for the dealership entity to determine if the potential customer has an existing relationship with a specific salesperson of the dealership entity includes:
identifying one or more loyalty aspects of the potential customer.

30. The computing system of claim 21 wherein distributing the new sales lead to a member of a pool of available salespeople of the dealership entity includes one or more of:
applying one or more queue overrides to the pool of available salespeople of the dealership entity;
applying the most specific queue override if multiple queue overrides are applicable; and
assigning the new sales lead to the coldest member of the pool of available salespeople.
